(19) United States
(12) Patent Application Publication
(10) Pub. No.: US 2022/0410978 A1
(43) Pub. Date: Dec. 29, 2022

(54) VEHICLE REAR STRUCTURE

(71) Applicant: HONDA MOTOR CO., LTD., Minato-ku, Tokyo (JP)

(72) Inventor: Tomoya Takeda, Wako-shi (JP)

(21) Appl. No.: 17/621,267

(22) PCT Filed: Jun. 4, 2020
(86) PCT No.: PCT/JP2020/022089

§ 371 Date: Dec. 21, 2021

(30) Foreign Application Priority Data
Jun. 27, 2019 (JP) 2019-119893

(51) Int. Cl. B62D 25/08

(52) U.S. Cl. CPC B62D 25/087

(57) ABSTRACT

A vehicle rear structure includes side reinforcing members and a support member. The side reinforcing members reinforce rear damper housings. The support member includes an upper rod member, a lower rod member, and a posture maintaining member. The upper rod member lies across the side reinforcing members. The lower rod member is disposed below the upper rod member. The posture maintaining member is disposed between the upper rod member and the lower rod member and is joined to the upper rod member and the lower rod member at a plurality of places in a vehicle width direction.

### TECHNICAL FIELD

The present invention relates to a vehicle rear structure.

Priority is claimed on Japanese Patent Application No. 2019-119893, filed Jun. 27, 2019, the content of which is incorporated herein by reference.

### BACKGROUND ART

Regarding a vehicle rear structure, for example, a constitution in which rear bulkheads are provided between a casing and a luggage compartment and the rear bulkheads are formed as ring-shaped skeletons so that the rear bulkheads include opening portions allowing so-called trunk-through between the casing and the luggage compartment is known. In this vehicle rear structure, a plurality of pieces of pipe material and metal gussets are provided as reinforcing members in the opening portions of the rear bulkheads. Accordingly, in a state in which the opening portions are constituted to allow trunk-through, strengths and rigidities of the rear bulkheads (that is, a rear portion of a vehicle body) are secured (for example, refer to Patent Literature 1).

### CITATION LIST

### Patent Literature

### [Patent Literature 1]

Japanese Patent No. 5689489

### SUMMARY OF INVENTION

### Technical Problem

However, the vehicle rear structure of Patent Literature 1 employs a plurality of pieces of pipe material and gussets as reinforcing members. However, rear bulkheads receive stresses in various directions from rear wheels disposed on lateral sides. Therefore, weight reduction is required by employing a reinforcing structure suitable for those stresses.

Aspects according to the present invention have been made in consideration of the foregoing circumstances, and an object thereof is to provide a vehicle rear structure in which the strength and the rigidity of a rear portion of a vehicle body can be secured in a state of retaining trunk-through opening portions in rear bulkheads and in which weight reduction can also be achieved.

### Solution to Problem

In order to resolve the foregoing problems, the present invention employs the following aspects.

(1) A vehicle rear structure according to an aspect of the present invention includes side reinforcing members that are provided on both sides of a vehicle to reinforce rear damper housings provided on both sides of the vehicle, and a support member that lies across the side reinforcing members. The support member includes an upper rod member which lies across the side reinforcing members, a lower rod member which is disposed below the upper rod member, and a posture maintaining member which is disposed between the upper rod member and the lower rod member and is joined to the upper rod member and the lower rod member at a plurality of places in a vehicle width direction.

According to the aspect of (1), when one of the rear tires on both sides of the vehicle runs into a bump on a road surface, an upward stress is input to one side reinforcing member such that the one side reinforcing member is caused to move upward.

Here, regarding a comparative example, for example, when the support member is constituted of only two members such as the upper rod member and the lower rod member, a rectangular frame portion is formed by the side reinforcing members on both sides and the upper and lower rod members. For this reason, when an upward stress is input to one side reinforcing member, it is conceivable that the rectangular frame portion formed by the side reinforcing members on both sides and the upper and lower rod members be deformed into a parallelogram.

Hence, in the support member, the posture maintaining member is added between the upper rod member and the lower rod member, and the posture maintaining member is joined to the upper rod member and the lower rod member at a plurality of places in the vehicle width direction. Thus, the strength and the rigidity of the support member (that is, a rear portion of a vehicle body) can be secured by the posture maintaining member. Accordingly, when an upward stress is input to one side reinforcing member, deformation of the rectangular frame portion formed by the side reinforcing members on both sides and the upper and lower rod members into a parallelogram can be curbed by the posture maintaining member. That is, with a simple constitution in which the posture maintaining member is simply joined to the upper rod member and the lower rod member at a plurality of places in the vehicle width direction, upward movement of one side reinforcing member can be curbed. Accordingly, the strength and the rigidity of the rear portion of the vehicle body can be secured, and weight reduction of the support member can also be achieved.

In addition, the posture maintaining member is disposed between the upper rod member and the lower rod member. Thus, the support member can be disposed at lower portions of the side reinforcing members on both sides. Accordingly, trunk-through opening portions can be secured in rear bulkheads.

(2) A vehicle rear structure according to another aspect of the present invention includes side reinforcing members that are provided on both sides of a vehicle to reinforce rear damper housings provided on both sides of the vehicle, and a support member that lies across the side reinforcing members. The support member includes an upper rod member which lies across the side reinforcing members, and a lower rod member which is disposed below the upper rod member. The upper rod member differs from the lower rod member in length.

According to the aspect of (2), in the support member, the upper rod member is caused to differ from the lower rod member in length. Thus, a trapezoidal virtual contour is formed by the side reinforcing members on both sides and the upper rod member and the lower rod member. In addition, for example, the side reinforcing members are formed of materials such as steel plates or aluminum plates which are unlikely to stretch. Accordingly, when an upward stress is input to one side reinforcing member, upward movement of the one side reinforcing member can be curbed. That is, with a simple constitution in which the upper rod member is simply caused to differ from the lower rod member in length, upward movement of one side reinforcing member can be curbed. Accordingly, the strength and the rigidity of the rear portion of the vehicle body can be secured, and weight reduction of the support member can also be achieved.

In addition, due to the simple constitution in which the upper rod member is simply caused to differ from the lower rod member in length, for example, the support member can be provided at the lower portions of the side reinforcing members on both sides. Accordingly, the trunk-through opening portions can be retained in the rear bulkheads.

(3) In the aspect of the foregoing (1) or (2), in a side view, attachment portions of suspensions may be positioned along the side reinforcing members and extended lines of the side reinforcing members.

According to the aspect of (3), the attachment portions of the suspensions are positioned along the side reinforcing members and the extended lines of the side reinforcing members. Thus, loads input from the suspensions to the attachment portions are transferred to the side reinforcing members.

Here, the side reinforcing members are reinforced by the support member. Thus, the support strengths and the rigidities of the suspensions are secured. Accordingly, the side reinforcing members can withstand loads transferred from the attachment portions of the suspensions to the side reinforcing members.

(4) In the aspect of the foregoing (1) or (2), the side reinforcing members may form leg portions of rear bulkheads provided at front portions of the rear damper housings. The rear bulkheads may include a floor cross member which lies across lower end portions of the side reinforcing members and a rear parcel cross member which lies across upper end portions of the side reinforcing members, in addition to the side reinforcing members, and may be formed as ring-shaped skeletons having rectangular opening portions by the side reinforcing members on both sides of the vehicle, the floor cross member, and the rear parcel cross member.

According to the aspect of (4), the rear bulkheads are formed as ring-shaped skeletons, and the trunk-through opening portions are formed by the ring-shaped skeletons. Accordingly, the strengths and the rigidities of the trunk-through opening portions can be secured.

(5) In the aspect of the foregoing (1), the posture maintaining member may be at least one of a membrane member which covers an area between the upper rod member and the lower rod member, and coupling brackets which are provided on both sides of the vehicle and couple the upper rod member and the lower rod member to each other in a vertical direction.

According to the aspect of (5), a membrane member is adopted as the posture maintaining member. For example, the membrane member is formed using a belt-shaped steel plate or an aluminum plate. This membrane member is simply attached through continuous welding or partial welding in a state in which the area between the upper rod member and the lower rod member is covered. Since the membrane member is attached to the upper rod member and the lower rod member, when an upward stress is input to one side reinforcing member, deformation of the rectangular frame portion formed by the side reinforcing members on both sides and the upper and lower rod members into a parallelogram can be curbed by the membrane member.

That is, with a simple constitution in which the membrane member is simply joined to the upper rod member and the lower rod member at a plurality of places in the vehicle width direction, upward movement of one side reinforcing member can be curbed. Accordingly, the strength and the rigidity of the rear portion of the vehicle body can be secured, and weight reduction of the support member can also be achieved.

In addition, coupling brackets may be adopted as the posture maintaining member. The coupling brackets are provided on both sides of the vehicle and couple the upper rod member and the lower rod member to each other in the vertical direction. The coupling brackets are provided on both sides of the vehicle, and the upper rod member and the lower rod member are coupled to each other in the vertical direction by the coupling brackets. Thus, when an upward stress is input to one side reinforcing member, deformation of the rectangular frame portion formed by the side reinforcing members on both sides and the upper and lower rod members into a parallelogram can be curbed by the coupling brackets.

That is, with a simple constitution in which the upper rod member and the lower rod member are simply coupled to each other by the coupling brackets, upward movement of one side reinforcing member can be curbed. Accordingly, the strength and the rigidity of the rear portion of the vehicle body can be secured, and weight reduction of the support member can also be achieved.

In addition, the coupling brackets are members smaller than the membrane member. Thus, for example, even when the plate thicknesses of the coupling brackets are increased, an influence on weight reduction can be curbed to a low level, and the strength and the rigidity of the rectangular frame portion can be enhanced. In addition, the strength and the rigidity of the rectangular frame portion can be enhanced without increasing the plate thicknesses of the coupling brackets by devising the shapes and attachment positions of the coupling brackets.

(6) In the aspect of the foregoing (5), the membrane member may have a bead which extends in the vehicle width direction.

According to the aspect of (6), a bead is formed in the membrane member, and the bead extends in the vehicle width direction. Accordingly, it is possible to withstand a load in the vehicle width direction with the bead.

(7) In the aspect of the foregoing (6), the bead may have a central bead which extends in the vehicle width direction, and end beads which extend outward in the vehicle width direction from both end portions of the central bead and are formed to have smaller bead widths than the central bead. The membrane member may have positioning holes at parts where the end beads are formed.

According to the aspect of (7), the end beads extend outward in the vehicle width direction from both ends of the central bead. Accordingly, the strength and the rigidity in the vehicle width direction can be secured. In addition, the bead widths of the end beads are formed to be narrower than that of the central bead. Accordingly, in the membrane member, regions for forming the positioning holes can be secured at the parts where the end beads are formed.

(8) The aspect of the foregoing (2) may further include rear frames that have frame upper surfaces on which lower end portions of the side reinforcing members are provided on outward sides in the vehicle width direction. The upper rod member may be formed using a square bar fixed to the side reinforcing members. The lower rod member may be formed using a pipe material which has both end portions formed flat and of which both the end portions are fixed to inward sides on the frame upper surfaces in the vehicle width direction.

According to the aspect of (8), the lower end portions of the side reinforcing members are provided on the outward sides on the frame upper surfaces (upper surfaces) in the vehicle width direction, and the upper rod member is fixed to the side reinforcing members. In addition, both end portions of the lower rod member are fixed to the inward sides on the frame upper surfaces in the vehicle width direction. That is, the upper rod member becomes longer than the lower rod member. Thus, a trapezoidal virtual contour is formed by the side reinforcing members on both sides and the upper rod member and the lower rod member. Accordingly, when an upward stress is input to one side reinforcing member, a compressive force acts on the upper rod member, and a tensile force acts on the lower rod member.

Here, the upper rod member is formed using a square bar. Thus, deformation of the upper rod member can be curbed by the square bar withstanding a compressive force acting on the upper rod member. In addition, the lower rod member is formed using a pipe material. Thus, deformation of the lower rod member can be curbed by the pipe material withstanding a tensile force acting on the lower rod member.

That is, when an upward stress is input to one side reinforcing member, upward movement of the one side reinforcing member can be curbed.

In addition, the lower rod member is formed using a pipe material. Thus, both end portions of the lower rod member can be formed flat by squashing the pipe material. Accordingly, the lower rod member can be easily manufactured.

(9) In the aspect of the foregoing (4), the rear damper housings may be formed to have triangular shapes in a side view; and may include apex portions at which rear damper bases supporting dampers are provided, front inclined walls which are coupled to front end portions of the apex portions and form the front portions where the side reinforcing members are provided, and rear inclined walls which are coupled to rear end portions of the apex portions and are provided with damper base reinforcing members having the rear parcel cross member lying across the upper end portions thereof.

According to the aspect of (9), the side reinforcing members are provided in the front inclined walls of the rear damper housings, and the damper base reinforcing members are provided in the rear inclined walls. Thus, the rear damper bases are firmly reinforced by the side reinforcing members and the damper base reinforcing members. Accordingly, the support strengths and the support rigidities of the dampers can be enhanced by the rear damper bases.

(10) The aspect of the foregoing (9) may further include rear frames that have frame upper surfaces on which lower end portions of the side reinforcing members are provided on outward sides in the vehicle width direction. The side reinforcing members may include first reinforcing members which are provided in rear wheel housings on a side in front of the front inclined walls in a vehicle body and have L-shaped cross sections extending in a vertical direction, and second reinforcing members which extend downward along the rear wheel housings from lower end portions of the first reinforcing members and have extension portions having U-shaped cross sections provided on the frame upper surfaces.

According to the aspect of (10), the extension portions can be provided at parts on the outward sides on the frame upper surfaces in the vehicle width direction by causing the extension portions of the second reinforcing members to extend downward along the rear wheel housings. Thus, rod attachment parts for fixing the end portions of the lower rod member to the inward sides on the frame upper surfaces in the vehicle width direction can be secured.

(11) In the aspect of the foregoing (10), the second reinforcing members may include reinforcing main body portions which are joined to the first reinforcing members, and the extension portions which are constituted of different members with respect to the reinforcing main body portions and are provided at lower end portions of the reinforcing main body portions.

According to the aspect of (11), since the extension portions are constituted of different members with respect to the reinforcing main body portions of the second reinforcing members, the extension portions can be detached when the rear frames and a floor panel are connected to each other using a sealant. Accordingly, a sealant can be smoothly applied without being hindered by the extension portions, and thus workability of applying a sealant can be enhanced.

(12) The aspect of the foregoing (2) may further include a posture maintaining member that is disposed between the upper rod member and the lower rod member and is joined to the upper rod member and the lower rod member at a plurality of places in a vehicle width direction.

According to the aspect of (12), in a state in which the upper rod member is caused to differ from the lower rod member in length, the posture maintaining member is disposed between the upper rod member and the lower rod member. Accordingly, when an upward stress is input to one side reinforcing member, upward movement of the one side reinforcing member can be more favorably curbed.

In addition, the posture maintaining member is disposed between the upper rod member and the lower rod member. Thus, the support member can be disposed at lower portions of the side reinforcing members on both sides. Accordingly, trunk-through opening portions can be secured in rear bulkheads.

### Advantageous Effects of Invention

According to the aspects of the present invention, the strength and the rigidity of a rear portion of a vehicle body can be secured in a state of retaining trunk-through opening portions in rear bulkheads, and weight reduction can also be achieved.

### BRIEF DESCRIPTION OF DRAWINGS

FIG. 1 is a perspective view of a vehicle rear structure of a first embodiment according to the present invention viewed from obliquely above in front.

FIG. 2 is an enlarged perspective view of the part II in FIG. 1.

FIG. 3 is a perspective view of the vehicle rear structure of the first embodiment viewed from above on the left side.

FIG. 4 is a side view of the vehicle rear structure of the first embodiment.

FIG. 5 is a perspective view of the vehicle rear structure of the first embodiment viewed from obliquely behind.

FIG. 6 is an enlarged perspective view of the part VI in FIG. 2.

FIG. 7 is a cross-sectional view along line VII in FIG. 6.

FIG. 8 is a cross-sectional view of the vehicle rear structure of the first embodiment cut along a rear cross member.

FIG. 9 is a perspective view of the vehicle rear structure of the first embodiment viewed from behind a vehicle body.

FIG. 10 is a schematic view illustrating a support member of the first embodiment.

FIG. 11 is a schematic view illustrating a support member of a comparative example.

FIG. 12 is a schematic view illustrating a support member of a fourth embodiment.

FIG. 13 is a schematic view illustrating a support member of a fifth embodiment.

### DESCRIPTION OF EMBODIMENTS

Hereinafter, embodiments of the present invention will be described on the basis of the drawings. In the drawings of the embodiments, the arrow FR indicates a side in front of a vehicle 1, the arrow UP indicates a side above the vehicle 1, and the arrow LH indicates the left side of the vehicle 1.

### First Embodiment

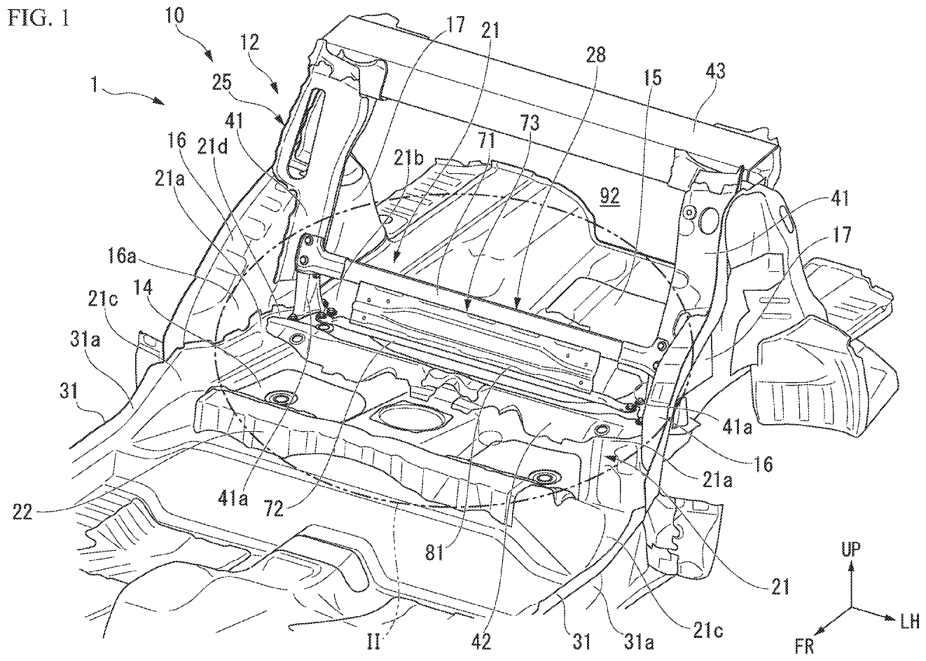

FIG. 1 is a perspective view of a vehicle rear structure 10 of the vehicle 1 viewed from obliquely above in front.

As illustrated in FIG. 1, the vehicle 1 includes the vehicle rear structure 10 at a rear portion of a vehicle body. The vehicle rear structure 10 has substantially a bilaterally symmetrical constitution. Hereinafter, description will be given by applying the same reference signs to constituent members on both left and right sides.

[Vehicle Rear Structure]

The vehicle rear structure 10 includes a skeletal member 12 constituting a skeleton of the vehicle rear structure 10, a rear floor panel 14, a luggage compartment floor panel 15, rear wheel housings 16, and rear damper housings 17. The rear wheel housings 16 and the rear damper housings 17 are provided on both sides of the vehicle 1.

<Skeletal Member>

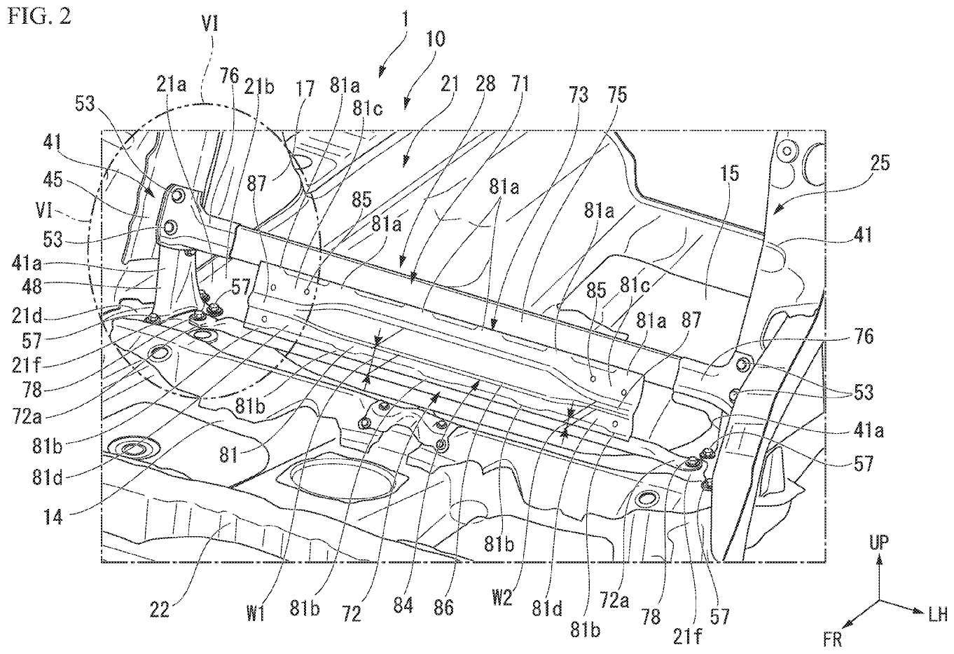

The skeletal member 12 includes rear frames 21, a center cross member 22, rear bulkheads 25, damper base reinforcing members 26 (refer to FIG. 2), and a support member 28. The rear frames 21 are provided on both sides of the vehicle 1.

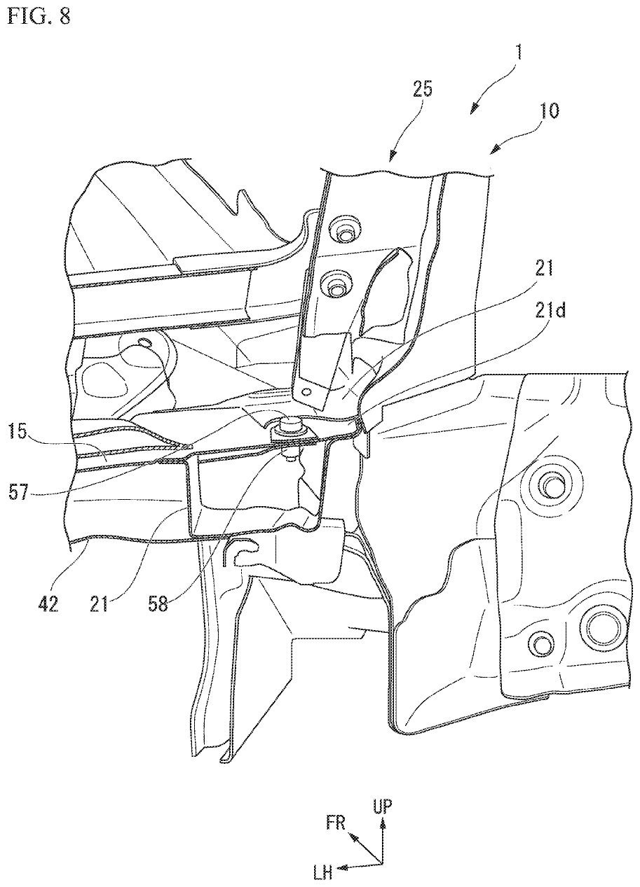

For example, the rear frames 21 are formed to have rectangular closed cross sections (also refer to FIG. 8) and extend toward a rear side of the vehicle body from rear end portions 31a of side sills 31 provided on both sides of the vehicle 1. In the rear frames 21, front portions 21a are provided along the inward sides of the rear wheel housings 16 in a vehicle width direction. The front portions 21a of the rear frames 21 are curved outward in the vehicle width direction toward a front side of the vehicle body along wheel front portions 16a of the rear wheel housings 16.

The rear frames 21 have frame upper surfaces (upper surfaces) 21b. The frame upper surfaces 21b are formed flat, and lower end portions of side reinforcing members 41 (which will be described below) are provided on outward sides in the vehicle width direction.

FIG. 2 is an enlarged perspective view of the part II in FIG. 1.

As illustrated in FIGS. 1 and 2, the center cross member 22 lies across front end portions 21c of the rear frames 21 on both sides of the vehicle 1 in the vehicle width direction. In the rear frames 21 on both sides of the vehicle 1, the rear bulkheads 25 are provided in frame bent portions 21d of the center cross member 22 on the rear side of the vehicle body. The frame bent portions 21d are parts where the rear frames 21 are curved outward in the vehicle width direction along front portions of the rear damper housings 17.

The support member 28 is provided at lower portions of the rear bulkheads 25. The rear bulkheads 25 and the support member 28 will be described below in detail.

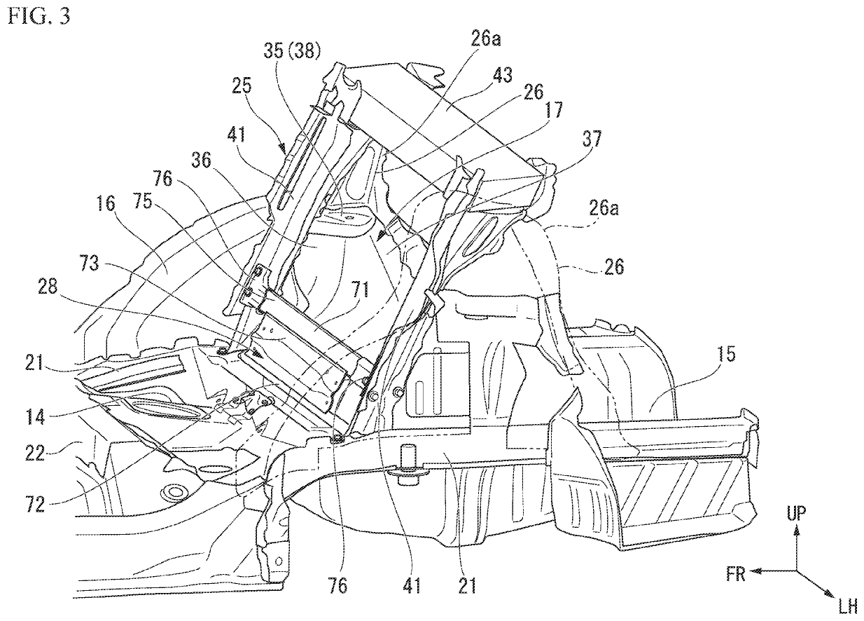

In the rear frames 21 on both sides of the vehicle 1, the damper base reinforcing members 26 (refer to FIG. 3) are provided at parts of the rear bulkheads 25 on the rear side of the vehicle body. In the damper base reinforcing members 26, upper end portions 26a are coupled to a rear parcel cross member 43 of the rear bulkheads 25.

The rear floor panel 14 is provided in the front portions 21a of the rear frames 21 on both sides of the vehicle 1, the center cross member 22, and a rear cross member 42 of the rear bulkheads 25. In the rear frames 21 on both sides of the vehicle 1, the luggage compartment floor panel 15 is provided at parts of the rear bulkheads 25 (specifically, the rear cross member 42) on the rear side of the vehicle body.

In addition, the rear wheel housings 16 are provided in the rear frames 21 from the outward side in the vehicle width direction. The rear wheel housings 16 are formed to have recessed shapes toward the inward sides in the vehicle width direction. Rear wheels (not illustrated) are accommodated in the rear wheel housings 16 from the outward side in the vehicle width direction. The rear damper housings 17 are provided in the rear wheel housings 16. The rear damper housings 17 are formed to have recessed shapes toward the inward sides in the vehicle width direction. Dampers (not illustrated) are accommodated in the rear damper housings 17 from the outward side in the vehicle width direction.

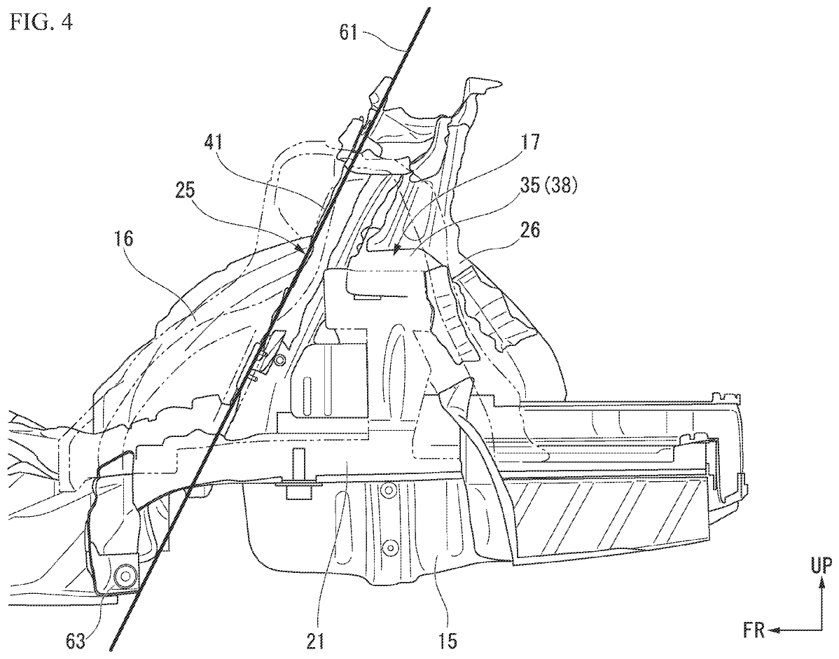

FIG. 3 is a perspective view of the vehicle rear structure 10 viewed from above on the left side. FIG. 4 is a side view of the vehicle rear structure 10.

As illustrated in FIGS. 3 and 4, the rear damper housings 17 have apex portions 35, front inclined walls 36, and rear inclined walls 37. The rear damper housings 17 are formed to have triangular shapes in a side view (specifically, trapezoidal shapes in a side view) by the apex portions 35, the front inclined walls 36, the rear inclined walls 37, and the rear frames 21. Rear damper bases 38 are provided at the apex portions 35. The rear damper bases 38 are disposed along the rear frames 21 at an interval above the rear frames 21. Apex portions of the dampers are supported by the rear damper bases 38.

The front inclined walls 36 are provided at front end portions of the apex portions 35 (that is, the rear damper bases 38). The front inclined walls 36 form the front portions of the rear damper housings 17. The side reinforcing members 41 (which will be described below) are provided at the front portions of the rear damper housings 17 (that is, the front inclined walls 36).

The rear inclined walls 37 are provided at rear end portions of the apex portions 35. The rear inclined walls 37 form rear portions of the rear damper housings 17. The damper base reinforcing members 26 are provided at the rear portions of the rear damper housings 17 (that is, the rear inclined walls 37). The rear parcel cross member 43 (which will be described below) of the rear bulkheads 25 lies across upper end portions of the damper base reinforcing members 26 on both sides of the vehicle 1.

Since the side reinforcing members 41 are provided in the front inclined walls 36 and the damper base reinforcing members 26 are provided in the rear inclined walls 37, the rear damper housings 17 (particularly, the rear damper bases 38) are firmly reinforced by the side reinforcing members 41 and the damper base reinforcing members 26. Accordingly, the support strengths and the support rigidities of the dampers are enhanced by the rear damper bases 38.

<Rear Bulkhead>

As illustrated in FIG. 1, the rear bulkheads 25 include the side reinforcing members 41, the rear cross member (floor cross member) 42, and the rear parcel cross member 43. The side reinforcing members 41 extend on the rear side of the vehicle body along the front inclined walls 36 of the rear damper housings 17 from the rear frames 21 provided on both sides of the vehicle 1, and in a shape inclined upward.

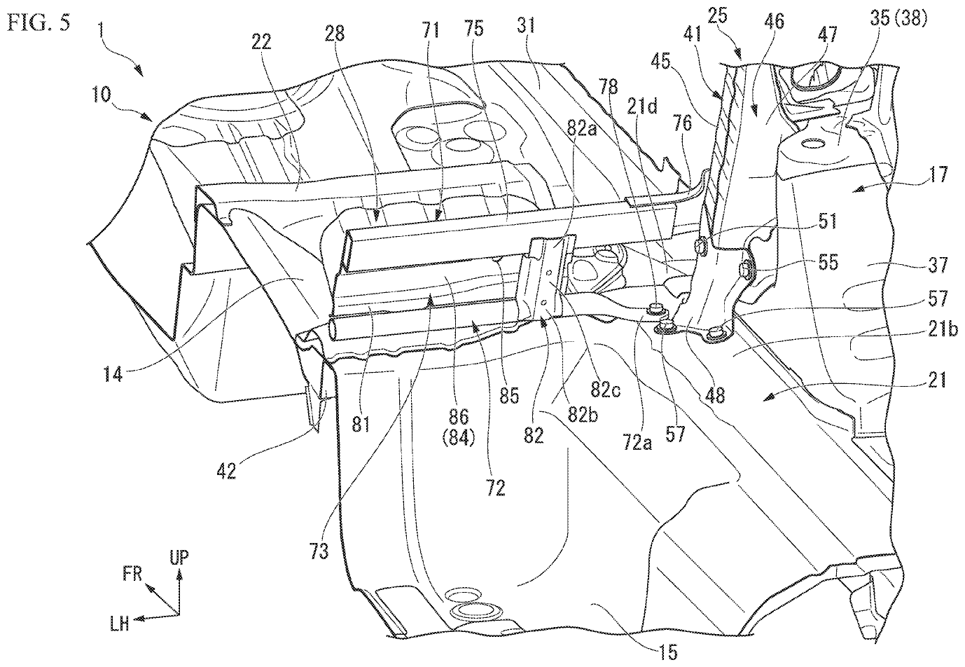

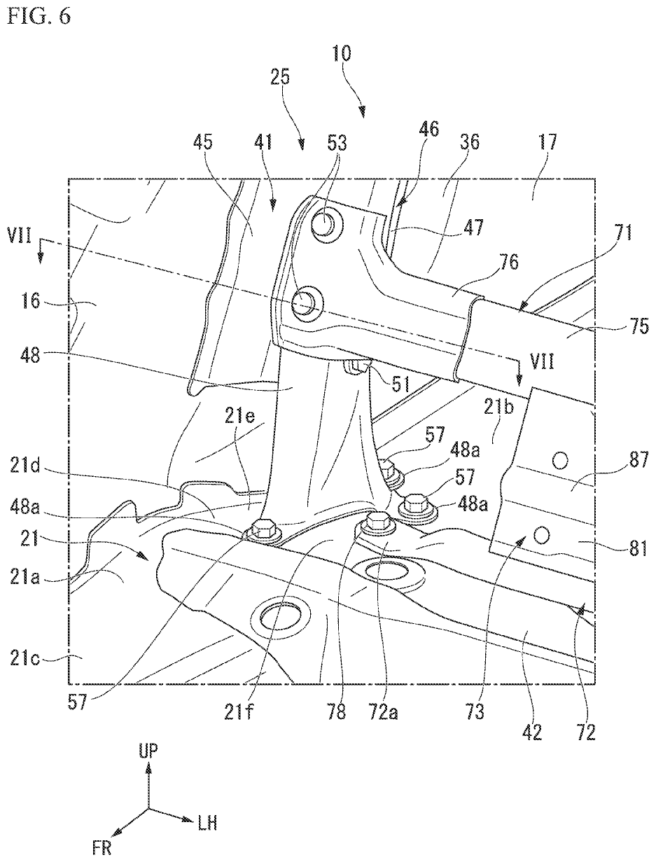

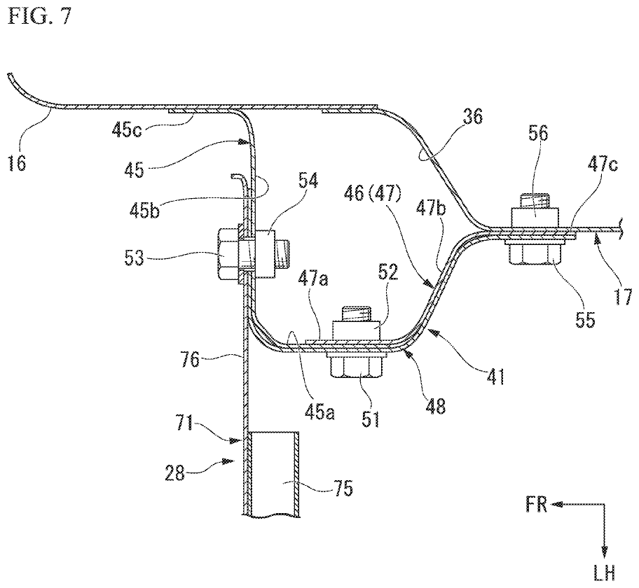

FIG. 5 is a perspective view of the vehicle rear structure 10 viewed from obliquely behind. FIG. 6 is an enlarged perspective view of the part VI in FIG. 2. FIG. 7 is a cross-sectional view along line VII in FIG. 6.

As illustrated in FIGS. 5, 6, and 7, for example, the side reinforcing members 41 are formed of steel plates or aluminum plates and include first reinforcing members 45 and second reinforcing members 46. The first reinforcing members 45 have first inner walls 45a, first front walls 45b, and first flanges 45c. The first reinforcing members 45 are formed to have L-shaped cross sections by the first inner walls 45a and the first front walls 45b. The first flanges 45c protrude toward the front side of the vehicle body from outer sides of the first front walls 45b to the rear side of the vehicle body. The first flanges 45c are joined to the rear wheel housings 16 on a side in front of the front inclined walls 36 in the vehicle body and extend in a vertical direction.

The second reinforcing members 46 are joined to the first reinforcing members 45. The second reinforcing members 46 include reinforcing main body portions 47 and extension portions 48. The reinforcing main body portions 47 have second inner walls 47a, second rear walls 47b, and second flanges 47c. The second reinforcing members 46 are formed to have L-shaped cross sections by the second inner walls 47a and the second rear walls 47b. The second flanges 47c protrude toward the front side of the vehicle body from outer sides of the second rear walls 47b to the rear side of the vehicle body. The second flanges 47c are joined to the front inclined walls 36 and extend in the vertical direction.

The second inner walls 47a of the reinforcing main body portions 47 are joined to the first inner walls 45a of the first reinforcing members 45. Accordingly, the first reinforcing members 45 (specifically, the first inner walls 45a and the first front walls 45b) and the reinforcing main body portions 47 (specifically, the second inner walls 47a and the second rear walls 47b) are formed to have U-shaped cross sections.

The extension portions 48 are attached to lower end portions of the first reinforcing members 45 and lower end portions of the reinforcing main body portions 47. Specifically, extension portions 48 are fastened to lower end portions of the first inner walls 45a and lower end portions of the second inner walls 47a using first bolts 51 and first nuts 52. In addition, the extension portions 48 are fastened to lower end portions of the first front walls 45b together with the support member 28 using second bolts 53 and second nuts 54. Moreover, the extension portions 48 are fastened to the rear damper housings 17 together with lower end portions of the second flanges 47c using third bolts 55 and third nuts 56.

That is, the extension portions 48 are constituted of different members with respect to the reinforcing main body portions 47. The extension portions 48 are provided at the lower end portions of the first reinforcing members 45 and the reinforcing main body portions 47, are formed to have U-shaped cross sections, and extend downward along the rear wheel housings 16 or the rear damper housings 17 from the lower end portions.

Since the extension portions 48 extend downward along the rear wheel housings 16 or the rear damper housings 17, the extension portions 48 are provided at parts 21e on the frame upper surfaces 21b on the outward sides in the vehicle width direction. Specifically, the extension portions 48 are attached to the frame upper surfaces 21b of the frame bent portions 21d by fastening lower end portions 48a to the parts 21e on the outward sides in the vehicle width direction using fourth bolts 57 and fourth nuts 58 (refer to FIG. 8).

Since the lower end portions 48a of the extension portions 48 are attached to the parts 21e on the outward sides in the vehicle width direction, rod attachment parts 21f are secured on the inward sides on the frame upper surfaces 21b in the vehicle width direction. Accordingly, end portions 72a of a lower rod member 72 (which will be described below) can be fixed to the rod attachment parts 21f.

In this manner, the extension portions 48 are constituted of different members with respect to the reinforcing main body portions 47 of the second reinforcing members 46. Thus, for example, when the rear frames 21 and the luggage compartment floor panel (floor panel) 15 are connected to each other using a sealant, the extension portions 48 can be detached from the lower end portions of the first reinforcing members 45 and the lower end portions of the reinforcing main body portions 47 by loosening the first to third bolts 51, 53, and 55. In addition, the extension portions 48 can be detached from the parts 21e on the outward sides in the vehicle width direction by loosening the fourth bolts 57. Accordingly, a sealant can be smoothly applied without being hindered by the extension portions 48, and thus workability of applying a sealant can be enhanced.

FIG. 8 is a cross-sectional view of the vehicle rear structure 10 cut along the rear cross member 42. As illustrated in FIGS. 5 and 8, the rear cross member 42 of the rear bulkheads 25 lies across the frame bent portions 21d of the rear frames 21 on both sides of the vehicle 1 in the vehicle width direction (also refer to FIG. 1). The rear cross member 42 is formed to have a rectangular closed cross section. Both end portions of the rear cross member 42 are coupled to the lower end portions of the extension portions 48 (that is, the lower end portions of the side reinforcing members 41) with the frame bent portions 21d therebetween.

As illustrated in FIG. 1, the rear parcel cross member 43 lies across upper end portions of the side reinforcing members 41 on both sides of the vehicle 1 in the vehicle width direction. The rear parcel cross member 43 is formed to have a rectangular closed cross section.

The rear bulkheads 25 are formed as ring-shaped skeletons having rectangular opening portions 92 by the side reinforcing members 41 on both sides of the vehicle 1, the rear cross member 42, and the rear parcel cross member 43. Here, the side reinforcing members 41 on both sides of the vehicle 1 are provided at the front portions of the rear damper housings 17 and form leg portions of rear bulkheads 25.

In this manner, since the rear bulkheads 25 are formed as ring-shaped skeletons, trunk-through opening portions are formed due to the ring-shaped skeletons. Accordingly, the strengths and the rigidities of the trunk-through opening portions are secured by the ring-shaped skeletons.

As illustrated in FIG. 4, in a side view, trailing arm attachment portions 63 and the rear damper bases 38 serving as attachment portions of suspensions are positioned along the side reinforcing members 41 and extended lines 61 of the side reinforcing members 41.

Here, being “along the side reinforcing members 41 and the extended lines 61 of the side reinforcing members 41” includes being along the side reinforcing members 41 and the extended lines 61 in a contact state and being along the side reinforcing members 41 and the extended lines 61 in the vicinity thereof.

Since the trailing arm attachment portions 63 and the rear damper bases 38 are positioned along the side reinforcing members 41 and the extended lines 61, loads input to the trailing arm attachment portions 63 and the rear damper bases 38 can be efficiently transferred to the side reinforcing members 41. The trailing arm attachment portions 63 are attached to the rear frames 21.

Here, the side reinforcing members 41 are reinforced by the support member 28, which will be described below. Thus, the support strengths and the rigidities of the suspensions are secured. Accordingly, the side reinforcing members 41 can favorably withstand loads transferred from the attachment portions (the trailing arm attachment portions 63 and the rear damper bases 38) of the suspensions to the side reinforcing members 41.

<Support Member>

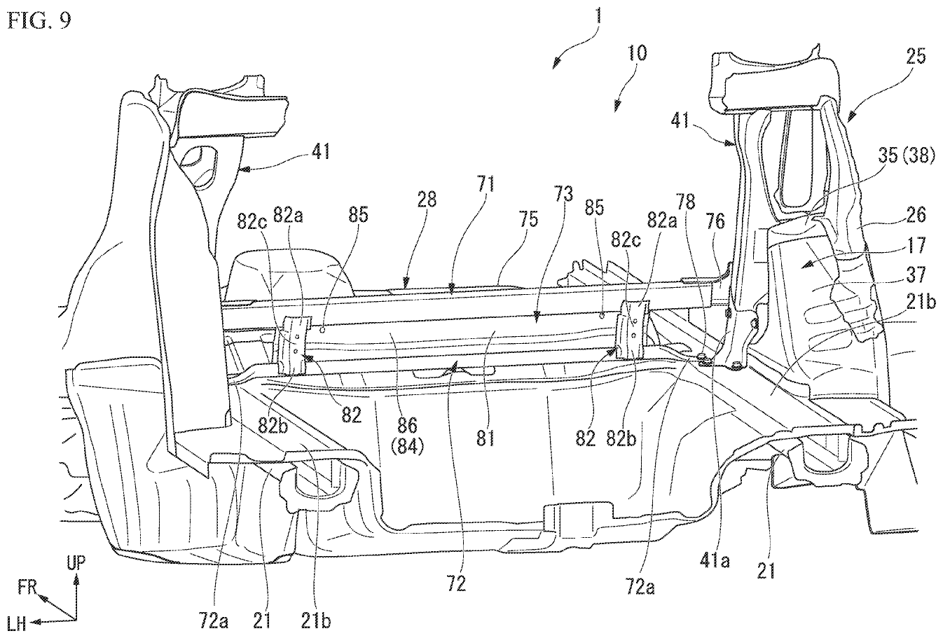

FIG. 9 is a perspective view of the vehicle rear structure 10 viewed from behind the vehicle body.

As illustrated in FIGS. 2, 5, and 9, in the side reinforcing members 41 on both sides of the vehicle 1, the support member 28 lies across lower portions 41a in the vehicle width direction. The support member 28 includes an upper rod member 71, the lower rod member 72, and a posture maintaining member 73.

The upper rod member 71 lies across the lower end portions of the first reinforcing members 45 and upper end portions of the extension portions 48 so that it is attached to the side reinforcing members 41 (specifically, the lower portions 41a thereof) on both sides of the vehicle 1 in the vehicle width direction. The upper rod member 71 includes a square member (square bar) 75 and attachment brackets 76. The square member 75 is formed to have a rectangular hollow cross section. The attachment brackets 76 are joined to both end portions of the square member 75. The attachment brackets 76 are fixed to the lower end portions of the first reinforcing members 45 and the upper end portions of the extension portions 48 by being fastened thereto using the second bolts 53 and the second nuts 54 (refer to FIG. 7).

The lower rod member 72 is disposed below the upper rod member 71. The lower rod member 72 is formed using a pipe material and has both end portions 72a which are formed flat by being squashed in a radial direction. Since the lower rod member 72 is formed using a pipe material, both the end portions 72a of the lower rod member 72 can be formed flat by squashing the pipe material. Accordingly, the lower rod member 72 can be easily manufactured.

Both the end portions 72a of the lower rod member 72 are fixed to the rod attachment parts 21f on the frame upper surfaces 21b by being fastened thereto using fifth bolts 78 and nuts (not illustrated). As described above, the rod attachment parts 21f are parts on the frame upper surfaces 21b of the frame bent portions 21d on the inward sides in the vehicle width direction. That is, the lower rod member 72 lies across the rod attachment parts 21f on both sides of the vehicle 1 so that it is disposed in the vehicle width direction.

The posture maintaining member 73 is disposed between the upper rod member 71 and the lower rod member 72. For example, the posture maintaining member 73 includes a plate member (membrane member) 81 and coupling brackets 82. In the first embodiment, an example including both members such as the plate member 81 and the coupling brackets 82 as the posture maintaining member 73 has been described, but any one of the plate member 81 and the coupling brackets 82 may serve as a posture maintaining member.

For example, the plate member 81 is formed to have a rectangular shape using a belt-shaped steel plate or an aluminum plate. In addition, the plate member 81 is disposed from the front side of the vehicle body such that an area between the upper rod member 71 and the lower rod member 72 is covered. Specifically, in the plate member 81, an upper side portion is joined to the upper rod member 71 at a plurality of places 81a in the vehicle width direction, and a lower side portion is joined to the lower rod member 72 at a plurality of places 81b in the vehicle width direction.

The plate member 81 has a bead 84 and positioning holes 85. The bead 84 extends in the vehicle width direction and has a central bead 86 and end beads 87. The central bead 86 is provided at the center of the plate member 81 in the vehicle width direction and at the center thereof in the vertical direction. The central bead 86 extends in the vehicle width direction in a state of protruding toward the front side of the vehicle body.

The end beads 87 extend outward in the vehicle width direction from both end portions of the central bead 86. The end beads 87 extend outward in the vehicle width direction from the end portions of the central bead 86 in a state of protruding toward the front side of the vehicle body. Bead widths W2 of the end beads 87 are formed to be narrower than a bead width W1 of the central bead 86.

The strength and the rigidity in the vehicle width direction can be secured in the plate member 81 by causing the bead 84 to extend in the vehicle width direction. Accordingly, for example, when a load is input to the support member 28 from the outward side in the vehicle width direction, the bead 84 can withstand the input load.

In addition, in the plate member 81, since the bead widths W2 of the end beads 87 are formed to be narrower than the bead width W1 of the central bead 86, an upper flat region 81c and a lower flat region 81d, which are relatively large, are secured at upper and lower parts where the end beads 87 are provided. The positioning holes 85 are formed in the upper flat region 81c which has been secured in a relatively large manner. That is, the positioning holes 85 are formed at both end portions of the plate member 81.

For example, the positioning holes 85 are used when positioning of the support member 28 is performed with respect to the lower portions 41a of the side reinforcing members 41 or the rod attachment parts 21f on the frame upper surfaces 21b.

In addition, the coupling brackets 82 are provided on both sides of the vehicle 1 (specifically, both end portions of the plate member 81) between the upper rod member 71 and the lower rod member 72. The coupling brackets 82 are disposed in the vertical direction such that the upper rod member 71 and the lower rod member 72 are coupled to each other in the vertical direction. In the coupling brackets 82, an upper end portion 82a is joined to the upper rod member 71, and a lower end portion 82b is joined to the lower rod member 72. Moreover, each of the coupling brackets 82 has a central portion 82c between the upper end portion 82a and the lower end portion 82b. The central portion 82c is formed to have a hat-shaped cross section, and flanges on both sides are joined to the end portions of the plate member 81. A closed cross section is formed in the central portion 82c and the plate member 81.

In this manner, the plate member 81 is joined to the upper rod member 71 and the lower rod member 72 at the plurality of places 81a and 81b in the vehicle width direction, and the coupling brackets 82 are also coupled to the upper rod member 71 and the lower rod member 72 on both sides of the vehicle 1. Accordingly, the strength and the rigidity of the support member 28 are secured by the posture maintaining member 73.

Next, an example of a case in which an upward stress F1 is input to one side reinforcing member 41 of the vehicle 1 will be described on the basis of FIGS. 1, 10, and 11.

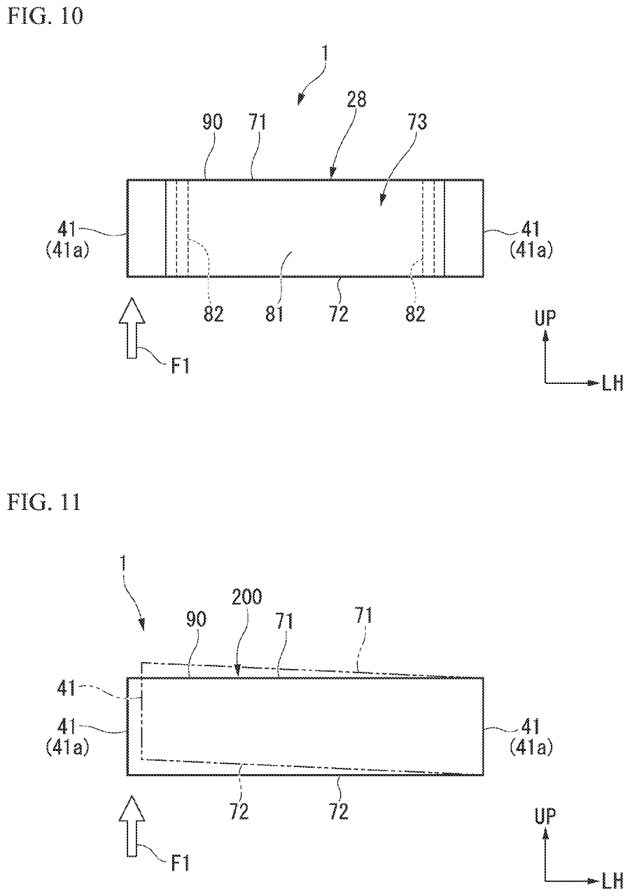

FIG. 10 is a schematic view illustrating the support member 28 of the first embodiment. FIG. 11 is a schematic view illustrating a support member 200 of a comparative example.

As illustrated in FIGS. 1 and 10, according to the support member 28 of the first embodiment, the support member 28 lies across the side reinforcing members 41 on both sides of the vehicle 1. Thus, a rectangular frame portion 90 is formed by the side reinforcing members 41 on both sides, the upper rod member 71, and the lower rod member 72. The posture maintaining member 73 is provided in this frame portion 90. For example, the posture maintaining member 73 includes the plate member 81 and the coupling brackets 82. Thus, the strength and the rigidity of the support member 28 are secured by the posture maintaining member 73. Since the strength and the rigidity of the support member 28 are secured, the strength and the rigidity of the rear portion of the vehicle body (particularly, the rear bulkheads 25) are secured.

Here, when one of the rear tires on both sides of the vehicle 1 runs into a bump on a road surface, the upward stress F1 is input to one side reinforcing member 41 of the vehicle 1. The strength and the rigidity of the support member 28 of the first embodiment are secured by the posture maintaining member 73. Accordingly, when the upward stress F1 is input to one side reinforcing member 41, deformation of the frame portion 90 from a rectangular shape to a parallelogram can be curbed by the posture maintaining member 73.

In this manner, in the support member 28, the plate member 81 is joined to the upper rod member 71 and the lower rod member 72 in the vehicle width direction at the plurality of places 81a and 81b, and the coupling brackets 82 are coupled to the upper rod member 71 and the lower rod member 72. With this simple constitution, upward movement of one side reinforcing member 41 due to the upward stress F1 can be curbed. Accordingly, the strength and the rigidity of the rear portion of the vehicle body (particularly, the rear bulkheads 25) can be secured, and weight reduction of the support member 28 can also be achieved.

In addition, the posture maintaining member 73 is disposed between the upper rod member 71 and the lower rod member 72. Thus, the support member 28 can be disposed at the lower portions 41a of the side reinforcing members 41 on both sides of the vehicle 1. Accordingly, the trunk-through opening portions 92 can be secured in the rear bulkheads 25.

As illustrated in FIGS. 1 and 11, according to the support member 200 of the comparative example, the support member 200 lies across the side reinforcing members 41 on both sides of the vehicle 1. The support member 200 includes the upper rod member 71 and the lower rod member 72. Thus, the rectangular frame portion 90 is formed by the side reinforcing members 41 on both sides, the upper rod member 71, and the lower rod member 72. That is, the support member 200 of the comparative example differs from the support member 28 of the first embodiment in that the posture maintaining member 73 of the first embodiment is not provided.

Here, when one of the rear tires on both sides of the vehicle 1 runs into a bump on a road surface, the upward stress F1 is input to one side reinforcing member 41 of the vehicle 1. The support member 28 of the comparative example is not provided with the posture maintaining member 73 of the first embodiment. Thus, it is conceivable that the frame portion 90 formed by the side reinforcing members 41 on both sides, the upper rod member 71, and the lower rod member 72 be deformed from a rectangular shape to a parallelogram indicated by the virtual line due to the input stress F1. For this reason, in the support member 200 of the comparative example, it is difficult to secure the strength and the rigidity of the rear portion of the vehicle body.

Next, support members of second to fifth embodiments will be described. In the support members of the second to fifth embodiments, description will be given by applying the same reference signs to members which are the same as or similar to the support member 28 of the first embodiment.

### Second Embodiment

First, the support member of the second embodiment will be described on the basis of FIG. 2. In the support member of the second embodiment, the posture maintaining member is constituted of only the plate member 81.

As illustrated in FIG. 2, in the plate member 81, similar to the first embodiment, the upper side portion is joined to the upper rod member 71 at the plurality of places 81a in the vehicle width direction, and the lower side portion is joined to the lower rod member 72 at the plurality of places 81b in the vehicle width direction. Accordingly, the strength and the rigidity of the support member of the second embodiment are secured by the plate member 81 (that is, the posture maintaining member).

That is, with a simple constitution in which the plate member 81 is simply joined to the upper rod member 71 and the lower rod member 72 at the plurality of places 81a and 81b in the vehicle width direction, upward movement of one side reinforcing member 41 can be curbed. Accordingly, the strength and the rigidity of the rear portion of the vehicle body can be secured, and weight reduction of the support member of the second embodiment can also be achieved.

### Third Embodiment

Next, the support member of the third embodiment will be described on the basis of FIG. 9. In the support member of the third embodiment, the posture maintaining member is constituted of only the coupling brackets 82.

As illustrated in FIG. 9, regarding the coupling brackets 82, similar to the first embodiment, the coupling brackets 82 are coupled to the upper rod member 71 and the lower rod member 72 on both sides of the vehicle 1. Accordingly, the strength and the rigidity of the support member of the third embodiment are secured by the coupling brackets 82 (that is, the posture maintaining member).

That is, with a simple constitution in which the coupling brackets 82 are simply coupled to the upper rod member 71 and the lower rod member 72, upward movement of one side reinforcing member 41 can be curbed. Accordingly, the strength and the rigidity of the rear portion of the vehicle body can be secured, and weight reduction of the support member of the third embodiment can also be achieved.

In addition, the coupling brackets 82 are members smaller than the plate member 81. Thus, for example, even when the plate thicknesses of the coupling brackets 82 are increased, an influence on weight reduction can be curbed to a low level, and the strength and the rigidity of the rectangular frame portion 90 (refer to FIG. 10) can be enhanced.

In addition, the strength and the rigidity of the rectangular frame portion 90 can be enhanced without increasing the plate thicknesses of the coupling brackets 82 by devising the shapes and attachment positions of the coupling brackets 82.

### Fourth Embodiment

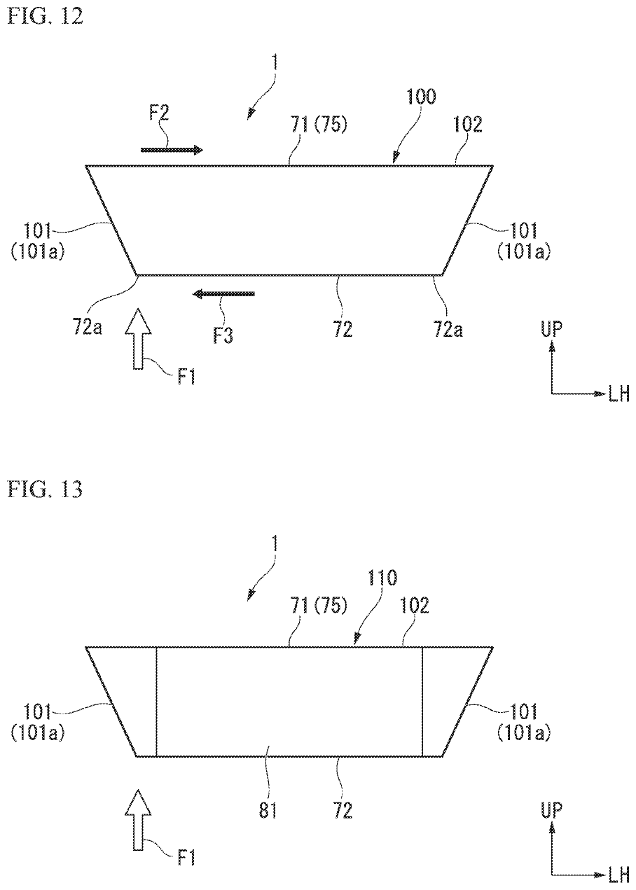

Next, a support member 100 of the fourth embodiment will be described on the basis of FIG. 12. The support member 100 of the fourth embodiment is constituted such that the upper rod member 71 and the lower rod member 72 differ from each other in length.

FIG. 12 is a schematic view illustrating the support member 100 of the fourth embodiment.

As illustrated in FIG. 12, in side reinforcing members 101, similar to the side reinforcing members 41 of the first embodiment, the lower end portions are provided on the outward sides on the frame upper surfaces 21b (refer to FIG. 6) in the vehicle width direction. The upper rod member 71 is fixed to the side reinforcing members 101. In addition, similar to the first embodiment, both the end portions 72a of the lower rod member 72 are fixed to the inward sides on the frame upper surfaces 21b in the vehicle width direction. That is, the upper rod member 71 becomes longer than the lower rod member 72.

Thus, according to the support member 100, a frame portion 102 formed by the side reinforcing members 101 on both sides, the upper rod member 71, and the lower rod member 72 has a trapezoidal virtual contour. In addition, for example, similar to the side reinforcing members 41 of the first embodiment, the side reinforcing members 101 are formed of materials such as steel plates or aluminum plates which are unlikely to stretch.

Here, when one of the rear tires on both sides of the vehicle 1 runs into a bump on a road surface, the upward stress F1 is input to one side reinforcing member 101 of the vehicle 1. In the support member 100, the frame portion 102 is formed to have a trapezoidal virtual contour, and the side reinforcing members 101 are formed of materials such as steel plates or aluminum plates which are unlikely to stretch. Thus, when the upward stress F1 is input to one side reinforcing member, a compressive force F2 acts on the upper rod member 71, and a tensile force F3 acts on the lower rod member 72.

Similar to the first embodiment, the upper rod member 71 is formed using the square member 75. Thus, the square member 75 withstands the compressive force F2 acting on the upper rod member 71 so that deformation of the upper rod member 71 can be curbed. In addition, similar to the first embodiment, the lower rod member 72 is formed using a pipe material. Thus, the pipe material withstands the tensile force F3 acting on the lower rod member 72 so that deformation of the lower rod member 72 can be curbed.

Accordingly, when the upward stress F1 is input to one side reinforcing member, upward movement of the one side reinforcing member 101 can be curbed.

That is, with a simple constitution in which the length of the upper rod member 71 is simply caused to differ from the length of the lower rod member 72, upward movement of one side reinforcing member 101 can be curbed. Accordingly, the strength and the rigidity of the rear portion of the vehicle body can be secured, and weight reduction of the support member 100 can also be achieved.

In addition, due to the simple constitution in which the length of the upper rod member 71 is simply caused to differ from the length of the lower rod member 72, for example, the support member 100 can be provided at lower portions 101a of the side reinforcing members 101 on both sides. Accordingly, the trunk-through opening portions can be retained in the rear bulkheads.

### Fifth Embodiment

Next, a support member 110 of the fifth embodiment will be described on the basis of FIG. 13. The support member 110 of the fifth embodiment is constituted by providing the plate member 81 in the support member 100 of the fourth embodiment as a posture maintaining member.

FIG. 13 is a schematic view illustrating the support member 110 of the fifth embodiment.

As illustrated in FIG. 13, in the support member 110, similar to the fourth embodiment, the frame portion 102 is formed to have a trapezoidal virtual contour. Thus, when one of the rear tires on both sides of the vehicle 1 runs into a bump on a road surface and the upward stress F1 is input to one side reinforcing member 101 of the vehicle 1, upward movement of one side reinforcing member 101 can be curbed.

Furthermore, the support member 110 includes the plate member 81 as a posture maintaining member. In the plate member 81, similar to the first embodiment, the upper side portion is joined to the upper rod member 71 at the plurality of places 81a (refer to FIG. 2) in the vehicle width direction, and the lower side portion is joined to the lower rod member 72 at the plurality of places 81b (refer to FIG. 2) in the vehicle width direction. Thus, the strength and the rigidity of the support member of the fifth embodiment are secured by the plate member 81 (that is, the posture maintaining member). Accordingly, when the upward stress F1 is input to one side reinforcing member 101, upward movement of one side reinforcing member 101 can be more favorably curbed.

That is, the length of the upper rod member 71 is caused to differ from the length of the lower rod member 72, and the plate member 81 (that is, the posture maintaining member) is disposed between the upper rod member 71 and the lower rod member 72. With this simple constitution, upward movement of one side reinforcing member 101 can be curbed. Accordingly, the strength and the rigidity of the rear portion of the vehicle body can be secured, and weight reduction of the support member 110 can also be achieved.

In addition, since the length of the upper rod member 71 is caused to differ from the length of the lower rod member 72 and the plate member 81 is disposed between the upper rod member 71 and the lower rod member 72, the support member 100 can be provided at the lower portions 101a of the side reinforcing members 101 on both sides. Accordingly, the trunk-through opening portions can be retained in the rear bulkheads 25 (refer to FIG. 1).

### Other Modification Examples

Hereinabove, preferable Examples of the present invention have been described, but the present invention is not limited to these Examples. Additions, omissions, replacements, and other changes of the constitutions can be made within a range not departing from the gist of the present invention. The present invention is not limited by the foregoing description and is limited by only the accompanying claims.

Further, within a range not departing from the gist of the present invention, the constituent elements in the embodiments described above can be suitably replaced with known constituent elements. In addition, the modification examples described above may be suitably combined.

### REFERENCE SIGNS LIST

1 Vehicle
10 Vehicle rear structure
16 Rear wheel housing
17 Rear damper housing
21 Rear frame
21b Frame upper surface
25 Rear bulkhead
26 Damper base reinforcing member
28, 100, 110 Support member
35 Apex portion
36 Front inclined wall
37 Rear inclined wall
38 Rear damper base (attachment portion of suspension)
41, 101 Side reinforcing member
42 Rear cross member (floor cross member)
43 Rear parcel cross member
45 First reinforcing member
46 Second reinforcing member
47 Reinforcing main body portion
48 Extension portion
61 Extended line of side reinforcing member
63 Trailing arm attachment portion (attachment portion of suspension)
71 Upper rod member
72 Lower rod member
72a End portion of lower rod member
73 Posture maintaining member
75 Square member (square bar)
81 Plate member (membrane member)
81c Upper flat region (part where end bead is formed)
82 Coupling bracket
84 Bead
85 Positioning hole
86 Central bead
87 End bead
92 Opening portion

What is claim is:

1. A vehicle rear structure comprising:
side reinforcing members that are provided on both sides of a vehicle to reinforce rear damper housings provided on both sides of the vehicle; and
a support member that lies across the side reinforcing members,
wherein the support member includes
an upper rod member which lies across the side reinforcing members,
a lower rod member which is disposed below the upper rod member, and
a posture maintaining member which is disposed between the upper rod member and the lower rod member and is joined to the upper rod member and the lower rod member at a plurality of places in a vehicle width direction.

2. A vehicle rear structure comprising:
side reinforcing members that are provided on both sides of a vehicle to reinforce rear damper housings provided on both sides of the vehicle; and
a support member that lies across the side reinforcing members,
wherein the support member includes
an upper rod member which lies across the side reinforcing members, and
a lower rod member which is disposed below the upper rod member, and
wherein the upper rod member differs from the lower rod member in length.

3. The vehicle rear structure according to claim 1 or 2,
wherein in a side view, attachment portions of suspensions are positioned along the side reinforcing members and extended lines of the side reinforcing members.

4. The vehicle rear structure according to claim 1,
wherein the side reinforcing members are provided at front portions of the rear damper housings and form leg portions of rear bulkheads, and
wherein the rear bulkheads
include a floor cross member which lies across lower end portions of the side reinforcing members and a rear parcel cross member which lies across upper end portions of the side reinforcing members, in addition to the side reinforcing members, and
are formed as ring-shaped skeletons having rectangular opening portions by the side reinforcing members on both sides of the vehicle, the floor cross member, and the rear parcel cross member.

5. The vehicle rear structure according to claim 1,
wherein the posture maintaining member is at least one of a membrane member which covers an area between the upper rod member and the lower rod member, and coupling brackets which are provided on both sides of the vehicle and couple the upper rod member and the lower rod member to each other in a vertical direction.

6. The vehicle rear structure according to claim 5,
wherein the membrane member has a bead which extends in the vehicle width direction.

7. The vehicle rear structure according to claim 6,
wherein the bead has a central bead which extends in the vehicle width direction, and end beads which extend outward in the vehicle width direction from both end portions of the central bead and are formed to have smaller bead widths than the central bead, and
wherein the membrane member has positioning holes at parts where the end beads are formed.

8. The vehicle rear structure according to claim 2 further comprising:
rear frames that have frame upper surfaces on which lower end portions of the side reinforcing members are provided on outward sides in the vehicle width direction,
wherein the upper rod member is formed using a square bar fixed to the side reinforcing members, and
wherein the lower rod member is formed using a pipe material which has both end portions formed flat and of which both the end portions are fixed to inward sides on the frame upper surfaces in the vehicle width direction.

9. The vehicle rear structure according to claim 4,
wherein the rear damper housings
are formed to have triangular shapes in a side view, and
include
apex portions at which rear damper bases supporting dampers are provided,
front inclined walls which are coupled to front end portions of the apex portions and form the front portions where the side reinforcing members are provided, and
rear inclined walls which are coupled to rear end portions of the apex portions and are provided with damper base reinforcing members having the rear parcel cross member lying across the upper end portions thereof.

10. The vehicle rear structure according to claim 9 further comprising:
rear frames that have frame upper surfaces on which lower end portions of the side reinforcing members are provided on outward sides in the vehicle width direction,
wherein the side reinforcing members include
first reinforcing members which are provided in rear wheel housings on a side in front of the front inclined walls in a vehicle body and have L-shaped cross sections extending in a vertical direction, and
second reinforcing members which extend downward along the rear wheel housings from lower end portions of the first reinforcing members and have extension portions having U-shaped cross sections provided on the frame upper surface.

11. The vehicle rear structure according to claim 10,
wherein the second reinforcing members include
reinforcing main body portions which are joined to the first reinforcing members, and
the extension portions which are constituted of different members with respect to the reinforcing main body portions and are provided at lower end portions of the reinforcing main body portions.

12. The vehicle rear structure according to claim 2 further comprising:
a posture maintaining member that is disposed between the upper rod member and the lower rod member and is joined to the upper rod member and the lower rod member at a plurality of places in a vehicle width direction.

13. The vehicle rear structure according to claim 2,
wherein in a side view, attachment portions of suspensions are positioned along the side reinforcing members and extended lines of the side reinforcing members.

14. The vehicle rear structure according to claim 2,
wherein the side reinforcing members are provided at front portions of the rear damper housings and form leg portions of rear bulkheads, and
wherein the rear bulkheads
include a floor cross member which lies across lower end portions of the side reinforcing members and a rear parcel cross member which lies across upper end portions of the side reinforcing members, in addition to the side reinforcing members, and
are formed as ring-shaped skeletons having rectangular opening portions by the side reinforcing members on both sides of the vehicle, the floor cross member, and the rear parcel cross member.
